(19) United States
(12) Patent Application Publication
(10) Pub. No.: US 2017/0133897 A1
(43) Pub. Date: May 11, 2017

(54) Axial Flux Electric Machine

(71) Applicant: Gordon S. Ritchie, London (GB)

(72) Inventor: Gordon S. Ritchie, London (GB)

(21) Appl. No.: 15/349,408

(22) Filed: Nov. 11, 2016

(30) Foreign Application Priority Data
Nov. 11, 2015 (GB) 1519864.1
Apr. 28, 2016 (GB) 1607443.7

(51) Int. Cl. H02K 1/27; H02K 3/18; H02P 27/06; H02K 1/14

(52) U.S. Cl. CPC H02K 1/2793; H02K 1/143; H02K 3/18; H02P 27/06

(57) ABSTRACT

An axial flux rotating machine comprises a rotatable component and a stator component. The rotatable component includes a rotor having an axis of rotation and an even number of permanent magnets disposed in a circle at a radial distance from said axis and supported for rotation about said axis. The stator component comprises at least one open ended transformer core member with one or more electrically conductive wire coils around the core member. The transformer core member and said rotatable component are aligned so that the permanent magnets induce an alternating magnetic field in the open ended transformer core or cores when the rotatable component rotates.

### FIELD OF THE INVENTION

The invention relates to an axial flux electric machine, such as a motor or generator or alternator.

### BACKGROUND

It is known for a radial flux permanent magnet motor/generator/alternator to have an external stator comprising thin permanent magnets and an internal rotor comprising motor laminations and copper winding wire.

It is also known for an axial flux permanent magnet motor/generator to have a stator containing thin or fat permanent magnets and a rotor containing flat coils of copper winding wire with no high permeability cores.

Neither of these designs is optimal magnetically.

### SUMMARY

Embodiments of the present invention use transformer laminations and transformer design, which generally have better magnetic flux circuits than electric motors, to improve upon an axial flux permanent magnet motor/generator/alternator.

According to one aspect of the present invention there is provided an axial flux rotating machine comprising a rotatable component and a stator component. The rotatable component includes a rotor having an axis of rotation and an even number of permanent magnets disposed in a circle at a radial distance from said axis and supported for rotation about said axis. The stator component comprises at least one open ended transformer core member with one or more electrically conductive wire coils around the core member. The transformer core member and said rotatable component are aligned so that the permanent magnets induce an alternating magnetic field in the open ended transformer cores when the rotatable component rotates.

An AC transformer has a primary winding and a secondary winding wrapped around a high permeability closed or slightly gapped core. The transformer converts electrical energy in the primary winding into magnetic energy in the core, which is converted back into electrical energy in the secondary winding. In embodiments of the present invention the primary winding is replaced by a second secondary winding and the high permeability core circuit excited magnetically by means of permanent magnets rather than by the primary winding. The transformer core has a gap large enough for a permanent magnet to pass through it. So the core circuit is interrupted by moving permanent magnets. The moving permanent magnets induce alternating flux in the core which is converted into electrical energy by the two secondary windings.

In this way the mechanical energy of the moving magnets is converted into magnetic flux in the core and then into electrical energy in the two secondary windings. The net result is that a transformer is turned into a motor/generator/alternator with twice as much power throughput as it had when acting as a transformer since in the present invention it has twice as much secondary winding space.

So rather than inducing an alternating magnetic flux by passing current through a primary winding around the core, the present invention induces it by passing permanent magnets through a gap in the magnetic core of the transformer.

### BRIEF DESCRIPTION OF THE DRAWINGS

FIG. 1 is a side view of an axial flux electric machine in accordance with an asymmetric single-sided embodiment.

FIG. 2 is a side view of an axial flux electric machine in accordance with a symmetric double-sided embodiment.

FIG. 3 shows side and axial views of an axial flux electric machine in accordance with an asymmetric single-sided embodiment.

FIG. 4 shows side and axial views of an axial flux electric machine in accordance with a symmetric double-sided embodiment.

FIG. 5 illustrates a single U-shaped transformer core forming part of an axial flux electric machine in accordance with an asymmetric single-sided embodiment.

FIG. 6 illustrates two U-shaped transformer cores forming part of an axial flux electric machine in accordance with a symmetric double-sided embodiment.

FIG. 7 is a side view of an axial flux electric machine in accordance with a toroidal embodiment.

FIGS. 8 to 10 are illustrations similar to those of FIGS. 1 to 7, of an axial flux electric machine embodiment referred to as the Saturn n,m motor/generator.

FIGS. 11 to 13 are axial views of embodiments of axial flux electric machine having different numbers of transformer cores.

FIG. 14 is a schematic diagram of a commutator for one phase of a stator coil of an axial flux machine.

FIG. 15 is a schematic diagram of a commutation circuit for one phase of a stator coil.

FIG. 16 is a schematic circuit of a synchronous modulated commutator for one phase or one stator coil.

FIG. 17 is a circuit diagram for a a synchronous modulated commutator for one phase or one stator coil.

FIGS. 18 to 22 are isometric views showing stages in the evolution of improvements to the rotor design of the Saturn n.m motor/generator embodiment of FIGS. 8 to 10.

FIG. 23 shows views of a pineapple embodiment of slotted rotor magnets.

FIG. 24 shows views of a spider's web embodiment of sliced rotor magnets.

FIG. 25 shows views of a pineapple embodiment of half thickness slotted rotor magnets.

FIG. 26 shows views of a spider's web embodiment of half thickness halbach slotted rotor magnets.

FIGS. 27 and 28 illustrate eddy-current reducing rings.

### DETAILED DESCRIPTION

Embodiments of the invention comprise a rotor shaft, a rotor disc, permanent magnets, one or more transformer cores or transformer type cores or transformer shaped cores and one or more coils of electrically conducting insulated wire wrapped around the transformer or transformer type or transformer shaped core or cores.

Embodiments preferably further comprise one or more bearings to hold the rotor shaft in position whilst it rotates.

Embodiments may also comprise means to fix the rotor disc to the rotor shaft, means to fix the rotor shaft axially to the rotating part of the bearing or bearings, means to hold the static parts of the bearing or bearings in position, means to hold the transformer core or cores in position, means to fix the permanent magnets to the rotor disc and means to ensure that the gap between the magnets on the rotor disc and the transformer cores is maintained accurately as the magnets rotate with the rotor disc.

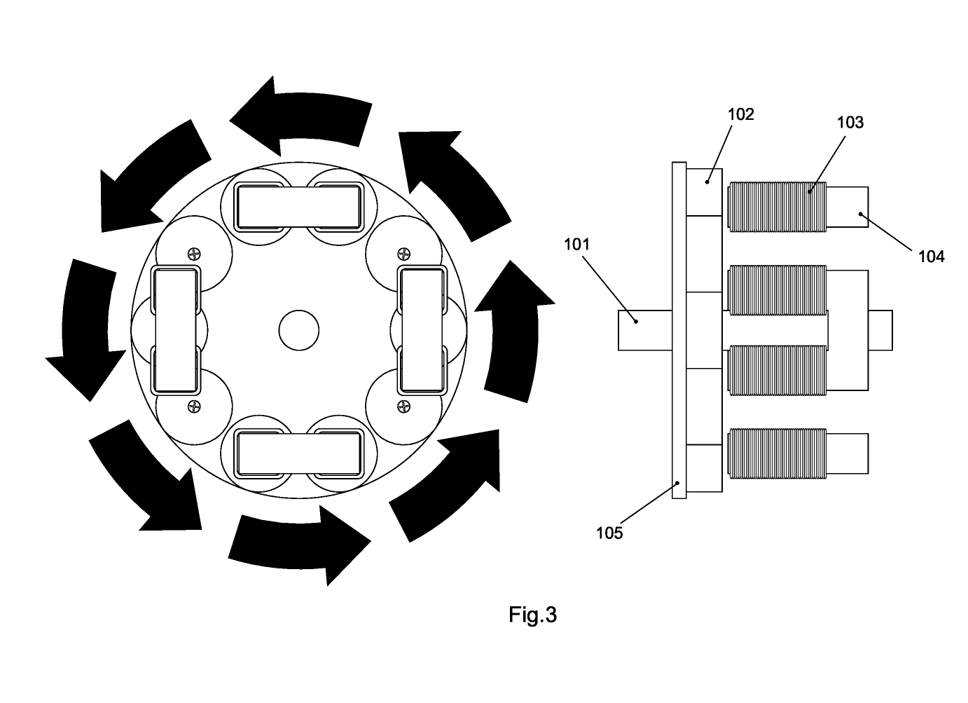

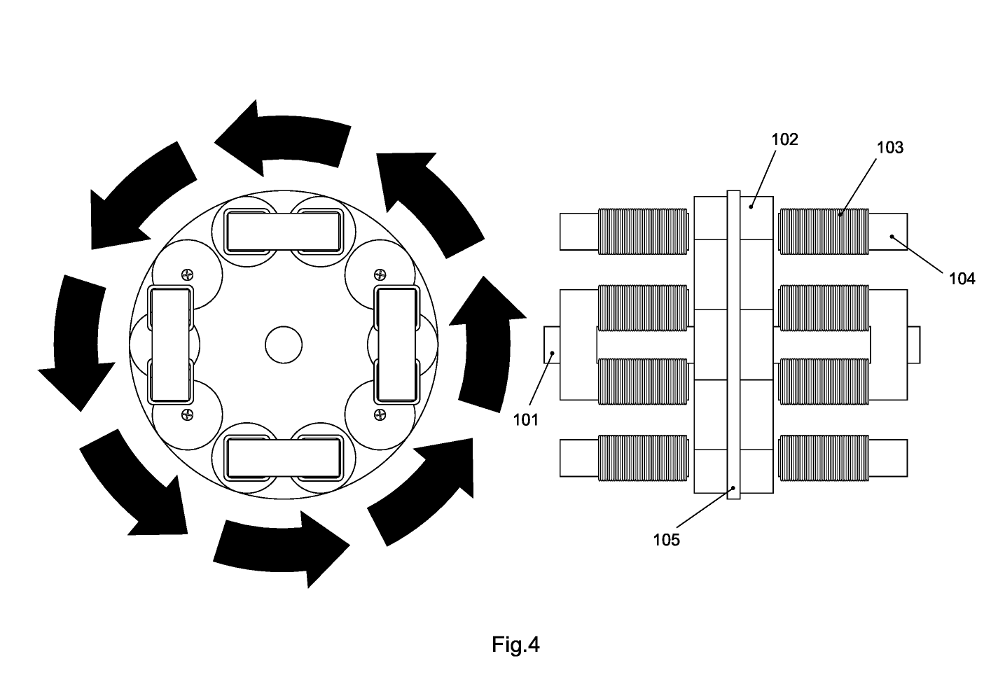

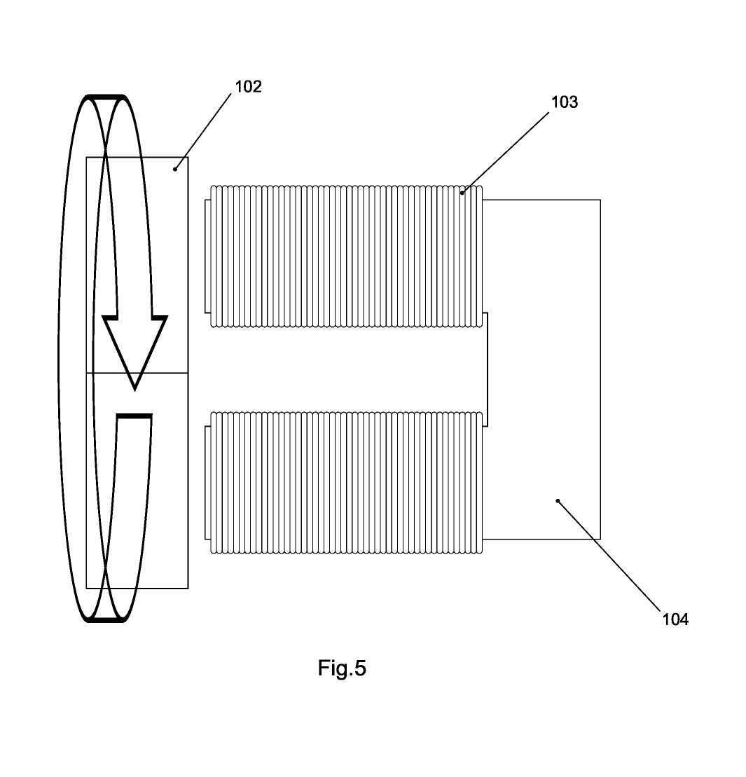

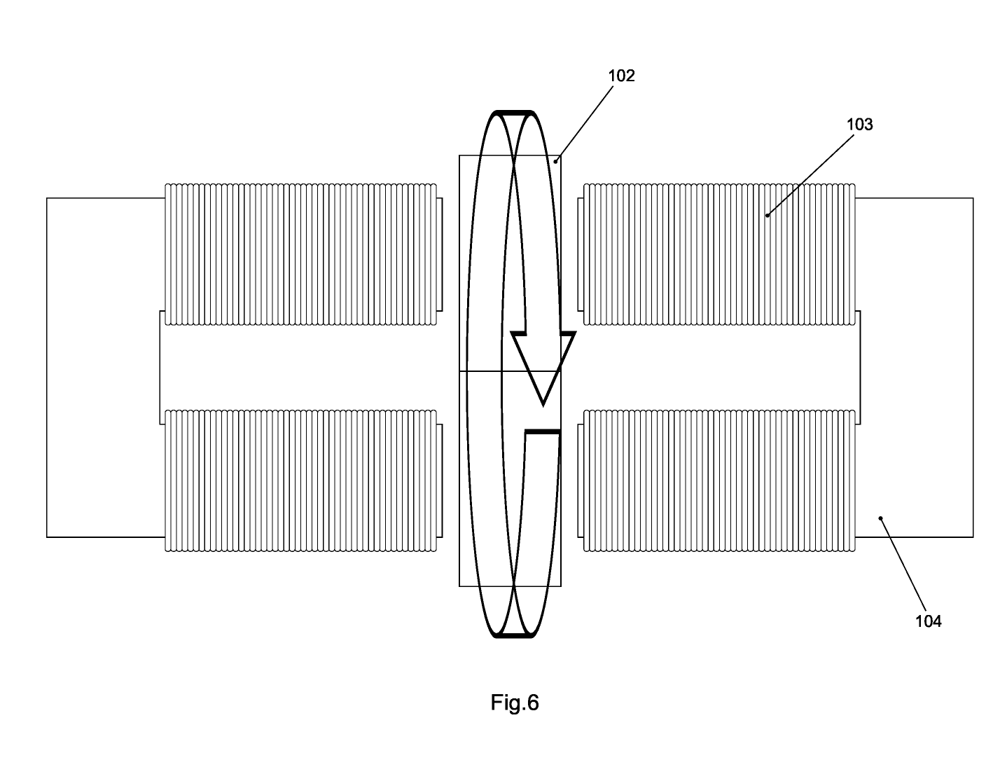

In embodiments of the invention, the magnets are arranged in alternating North Pole facing then South pole facing orientation, that is in alternating polarity, in a ring around the outside of the rotor disc so that they pass close to the transformer shaped/type cores—see FIG. 3 and FIG. 5 for the asymmetric single sided embodiment and FIG. 4 and FIG. 6 for the symmetric double sided embodiment.

In FIGS. 3 to 6 the parts are as follows . . .
101 is the Rotor Shaft.
102 is a Magnet
103 is a Coil
104 is a Core
105 is the Rotor Disc.

As the rotor disc rotates, the magnets, due to their alternating magnetic poles, induce an alternating magnetic field in the transformer cores.

The motor embodiment of the invention also comprises a commutator which provides an alternating current to the transformer coils which varies with the position of the magnets with respect to the cores, and is therefore dependent upon the rotational position of the rotor. Said means can include known brush type commutation means of a DC electric motor or can include known brushless type commutation means of a DC motor. Said means can include one more rotational position sensors for the rotor.

Said electronic commutation means can include semiconductor switches such as power MOSFETS.

### FIRST EMBODIMENT

In the first embodiment the rotor is a disc/cylinder to which are affixed or within which are embedded permanent magnets arranged in a ring pattern around the outside of the disc/cylinder. These magnets have alternating polarity and preferably have a length approaching, equal to, or greater than their diameter if cylindrical and their width if square or rectangular. Magnets of this aspect ratio have fewer losses because they hold their flux more strongly and because they demagnetize at a higher temperature, meaning that the motor can run hotter.

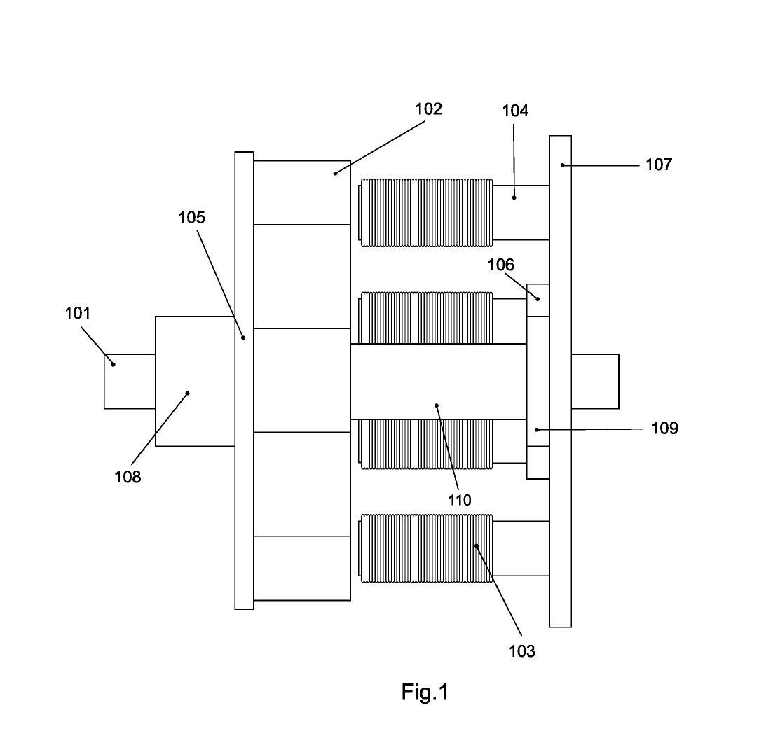

The Stator consists of U shaped transformer cores and wound coil formers/bobbins on each leg. The inventive step here is to use transformer technology in an axial flux electric motor/generator/alternator and for the alternating polarity permanent magnets on the rotor to induce within the transformer core a similar alternating magnetic flux to that which would be induced by a primary winding connected to an alternating current source. Then rather than the transformer having one primary winding and another secondary winding, it has two secondary windings, one on each arm, which convert the alternating magnetic field produced by the permanent magnets on the rotor into an alternating electrical current. The preferred means for ensuring that the rotor disc and the permanent magnets maintain a fixed gap between them and the cores is a shaft collar extending from the rotor disc to the bearing as depicted in FIG. 1 in which . . .
101 is the Rotor Shaft
102 is a Permanent Magnet
103 is a Coil
104 is a Transformer Core
105 is the Rotor Disc
106 is a Bearing Housing
107 is an End Plate
108 is a means for fixing the Rotor Disc to the Rotor Shaft. A Shaft Clamp.
109 is a Bearing
110 is a Shaft Collar

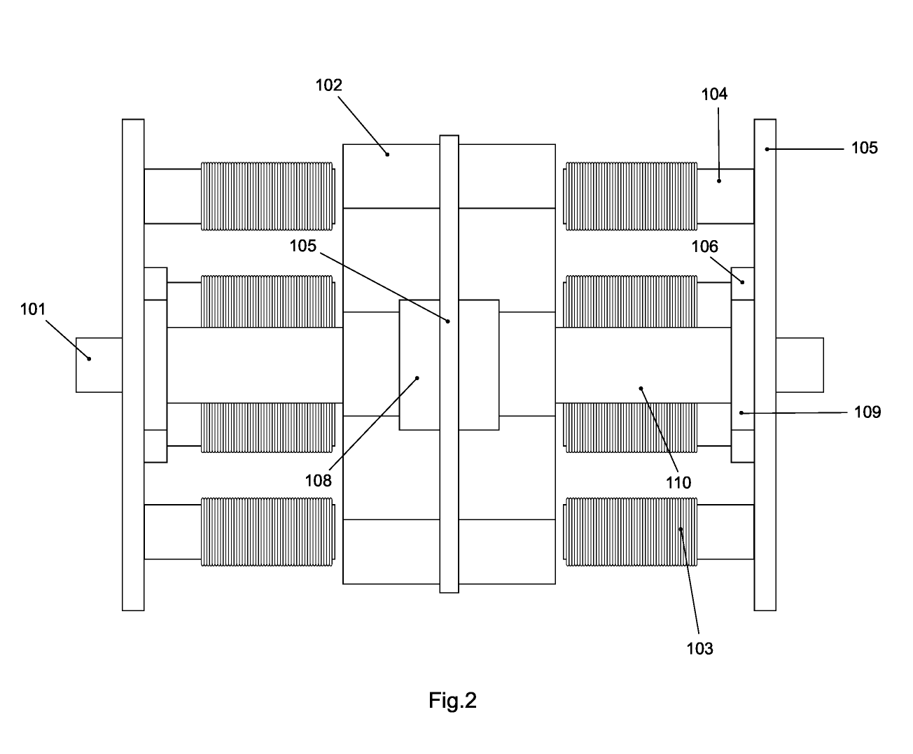

FIG. 2 is the symmetric or double sided version of the first embodiment of the invention.

The first advantage of this design is that the permanent magnets on the rotor can drive the transformer cores to near saturation and produce twice the power throughput that the transformer would have at 60 Hz in classic transformer operation since the primary winding is replaced by an additional secondary winding.

The classic transformer equation for the root mean squared electromotive force (EMF) generated in the transformer core for transformer use is.

E(rms)=4.443NB(max)AF

Where 4.443 is the square root of 2 (1.414) multiplied by pi (3.142) to 3 decimal places.
E(rms) is the root mean squared EMF
N is the number of turns
B(max) is the maximum magnetic field induced in the core
A is the cross sectional area of the core
F is the frequency of the induced magnetic field.

This formula also applies to the present invention, but the number of turns is doubled, since the primary coil of a transformer becomes a second secondary coil in the invention. So the EMF generated by a given alternating magnetic field in the core is doubled.

The second advantage of this design is that the rotor disc/cylinder can have many more than two permanent magnets arranged in a ring around its edge making a multipole design which is effectively a magnetic gearbox which increases the frequency seen by the transformer core to be a multiple of the frequency of the rotor disc. For example in the 10 permanent magnet design, which is a 10 pole motor/generator/alternator, the frequency of the alternating flux in the transformer cores is 5× the frequency of the rotor. Increasing the frequency of the alternating magnetic flux increases the power throughput of the transformer core in accordance with the transformer equation above.

This axial flux motor/generator/alternator design creates an essentially closed magnetic circuit which takes most of the magnetic flux from the permanent magnets and routes it through a high permeability transformer core. Since the magnets on the rotor are arranged in an alternating polarity pattern, the design preferably has an even number of magnets on the rotor.

The invention thereby applies transformer technology, transformer efficiency and transformer magnetics to an axial flux motor/generator/alternator.

In the first embodiment the centres of the magnets are separated by the same distance as the centres of the legs of the U cores. This results in a closed magnetic circuit as depicted in FIG. 5 and FIG. 6.

In the first embodiment of the invention the magnets and cores are arranged so that the rotor does not have a preferred position which it seeks. This can be done by arranging the positions of the cores so that when one core is perfectly aligned with two magnets on the rotor another core is as far away from such perfect alignment as is possible. This can be done with 4 Cores and 10 magnets as depicted by FIG. 3 in which

Or it can be done symmetrically with 8 cores and 20 magnets as depicted in FIG. 4.

In the 4 core 10 magnet asymmetric single sided design wherein the distance between the centres of the core legs and the centres of the magnets on the rotor is D. The transformer cores are arranged underneath the rotor magnets ½ D apart from each other. This geometry produces 2 in alignment cores and 2 out of alignment cores for every aligned rotor position. The same can be achieved with 8 cores ½ D apart and 20 magnets on the rotor disc or with 12 cores ½ D apart and 30 magnets on the rotor disc etc. There are many other geometries of the invention which result in the rotor having no preferred position.

In the symmetric, double sided version of the first embodiment of the invention, two sets of cores are placed on either side of the rotor—see FIG. 4. This doubles the maximum power throughput of the device and balances the axial loading on the rotor caused by magnetic attraction between the magnets on the rotor and the cores. This force can be quite substantial.

In the first motor embodiment of the invention (which is brushless) a sensor means is provided to determine the rotational position of the rotor. This means can be a hall effect sensor or an optical sensor for example. The signal from the sensor is used to control the current fed to the coils around the transformer cores through switches, preferably semiconductor switches such as ultra low impedance MOSFETs. The combination of the sensor and the switches and their control circuitry is essentially an electronic commutator for the motor, an inverter to drive the motor. This is known technology for a brushless DC motor. However in the first embodiment separate MOSFET switches are used for each coil on each leg of each transformer core. Increasing the number of MOSFETs reduces the total impedance of the motor circuitry, since they effectively run in parallel. This increases the efficiency of the motor inverter/controller/commutator.

In a classic embodiment of the motor version of the invention, an old fashioned brush and commutator system is used to alternate the power to the coils on the cores in such as way as to move the rotor. This technology has been known for a long time.

In a 2 phase first embodiment of the invention, two rotational position sensors can be employed—one for the switching of the current to the in-alignment cores (relative to some position) and the other for the out-of-alignment cores (relative to that position). This is essentially a 2 phase design. The signal fed to the commutator/inverter for the out of alignment cores will be 90 degrees out of phase to the signal for the in-alignment cores.

In the generator/alternator embodiment of the invention no sensors or switches or control circuits are required to produce power. The electricity that the invention generates will be AC at the frequency of the rotor multiplied by the number of its poles—which is half the number of magnets on the rotor.

If a certain frequency of AC is required then either the output of the invention can be rectified into DC and inverted to the desired frequency of AC, or the number of magnets on the rotor and the rpm of the mechanical drive can be adjusted to reach said frequency.

Commercial Version of the First Embodiment

In the commercial version of the first embodiment as of 2015, the transformer cores are made from laminations of electrical silicon steel. The coils are made from insulated copper wire, either circular cross section or preferably rectangular cross section copper strip wire. The permanent magnets are preferably high grade, preferably high temperature Neodymium, the rotor disc is aluminium, the rotor shaft is non magnetic stainless steel, the fixing bolts for the magnets are high tensile titanium or high tensile stainless steel to avoid the eddy currents induced in high tensile steel bolts.

Toroidal Embodiment

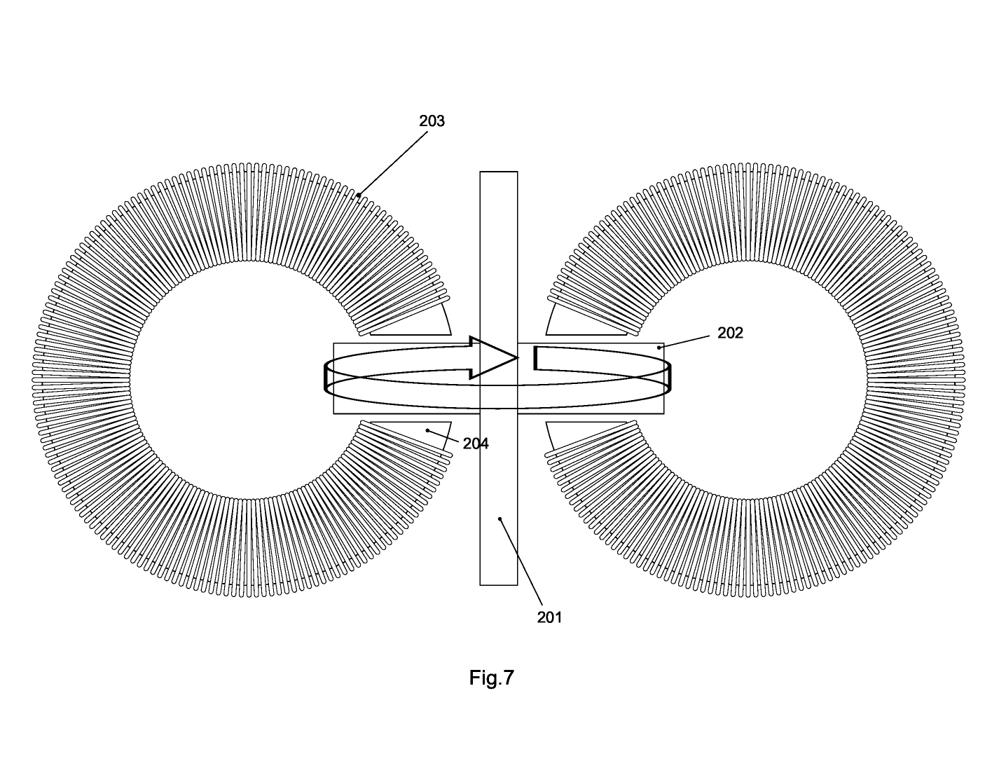

In this embodiment of the invention toroidal transformer cores are used rather than U shaped transformer cores. The resulting magnetic circuit is depicted in FIG. 7 wherein
201 is the Rotor Shaft
202 is a Magnet
203 is a Toroidal Coil
204 is a Toroidal Core

The toroidal core has a chunk removed from it large enough to fit a moving permanent magnet through. The functionality is the same as for the U shaped transformer core. But the geometry of the invention is wider and flatter. Again roughly twice as much power can be put through the transformer core in the present invention as can be done in classic toroidal transformer usage at 60 Hz, because the primary coil winding space is used as more secondary coil winding space.

Engineering Technicalities

The power output of the invention is directly proportional to the rpm of the rotor. And it increases non-linearly as the gap between the magnets on the rotor and the transformer cores decreases. So to achieve a light weight and powerful motor one needs to engineer a small gap between the cores and the magnets and a fast rotor.

However the closer the magnets are to the cores, the larger the attractive force between the two is. So it is important to prevent the rotor disc attaching itself to the cores. In the preferred first embodiment this is done with a relatively incompressible collar around the rotor shaft between the rotor disc and the bearing for the rotor shaft. Less preferably it can be achieved by shaft clamps.

The centrifugal force on the magnets at high rpm can be very substantial too. So they can either be bolted down onto the rotor disc with high tensile low permeability bolts or they can be embedded in the rotor disc so that the material of the disc prevents them from flying off the rotor. Or indeed they can be both embedded and bolted.

In the first embodiment for low rotor speed the magnets are bolted to the rotor disc with a countersunk high tensile bolt and have a countersunk socket in the magnet in order to create a flat surface at the magnet above the gap between the magnet and the core. Alternatively, the magnets can be bolted to the rotor disc via a diametric rather than axial hole.

In the first embodiment for high rotor speed the magnets are embedded rotor disc, so that the rotor disc material stops them flying off the rotor.

In the first embodiment the permanent magnets are Neodymium based sintered magnets since these have a very high magnetic remanence approaching 1.5 Tesla. In a high temperature high power embodiment, high temperature Neodymium based magnets can be used. Also Neodymium magnets keep their magnetization better at higher temperature if their axial length along which they are magnetized is increased compared to their radial dimension or width. So the preferred first embodiment has magnets which are longer axially than they are radially in the case of disc shaped magnets and longer than they are wide in the case of rectangular block shaped magnets which are magnetized along their length.

In the single-sided asymmetric embodiment of the invention, which has cores only on one side of the rotor, the attractive axial force can be significant and therefore an angular contact bearing or thrust bearing arranged to take a large axial force may be necessary for the rotor shaft.

In the double-sided symmetric embodiment of the invention which has cores on both sides of the rotor, the axial forces on the rotor shaft are less and the radial forces are more (from electromagnetic field equations). Therefore a deep grove ball bearing may be preferable.

The large forces in any powerful motor tend to cause vibration and resonance. In order to achieve improved smoothness of operation a low vibration embodiment of the invention comprises means to stick the core laminations together to provide core leg rigidity. This means can be a glue or a varnish or a filler or simply jamming too many laminations into each coil bobbin or any combination of the above.

To avoid vibration it is also important to ensure that the distances between the magnets on the rotor disc are all the same to within an acceptable tolerance and the gaps between the magnets and the transformer cores are all the same to within an acceptable tolerance and that said distances and gaps do not change significantly with heat or with rotational speed and the resulting centrifugal force or with time.

The Second Embodiment of the Invention

It is known for a radial flux permanent magnet motor/generator/alternator to have an external stator comprising thin permanent magnets and an internal rotor comprising motor laminations and copper winding wire.

It is also known for an axial flux permanent magnet motor/generator to have a stator containing thin or fat permanent magnets and a rotor containing flat coils of copper winding wire with no high permeability cores.

It is also known for an axial flux permanent magnet motor generator to have a stator containing several gapped toroid shaped or C shaped or claw shaped cores which save for a small air gap grab a disk shaped rotor upon which are fixed several permanent magnets of alternating polarity which pass through the gap in the toroids the C cores or the claw shaped cores. These cores are arranged around the edge of the disk shaped rotor as described in U.S. Pat. No. 6,552,460. Although that prior art restricts the circumferential cores to occur in multiples of 4 and the ratio of cores to permanent magnets to be 4:6 and the number of phases of the machine to be 4.

It is further known for an axial flux machine to have a U shaped core with legs receiving flux from non adjacent permanent magnets placed upon a disk shaped rotor as described in U.S. Pat. No. 5,179,307.

It is further known for a radial flux machine to have magnets of alternating polarity of the stator and U shaped cores receiving flux from adjacent stator magnets radially in the plane of the rotor as described in U.S. Pat. No. 6,249,071 B1.

It is further known for an axial flux machine to have U shaped cores with legs receiving flux from adjacent permanent magnets upon a disk shaped rotor wherein U shaped cores are provided either side of the rotor disk so that a continuous magnetic flux path is made not simply around two U shaped cores on either side of the two permanent magnets but instead around all the U shaped cores which are staggered as described in US patent US2011109185A.

The second embodiment of the present invention is an improvement to the Transformer inspired Axial flux Electric motor/generator/alternator disclosed in GB patent application GB1519864.1 of Nov. 11, 2015.

This embodiment of the present invention has a stator comprising a rotor disk to which are fixed an even number of permanent magnets in a ring shaped pattern with adjacent magnets having alternating polarity. The rotor magnets are equidistant one from another and their centres are arranged in a circle, the centre of which is the centre of the rotor disk. The permanent magnets are magnetized axially with respect to the rotor. They are magnetized in the direction of the axis of rotation of the rotor.

The stator comprises one or more double legged cores, preferably rectangular U shaped cores, preferably made of several thin laminations of electrical steel. These cores are positioned to provide a predominantly axial and tangential circuit for the magnetic flux from two adjacent permanent magnets on the rotor. The core or cores are all positioned on the same side of the rotor.

An aspect of this embodiment of the present invention which is an improvement, is the closing of that magnetic circuit by the addition of a flux carrying means behind the permanent magnets on the rotor. Said means is preferably several ring shaped thin laminations of electrical steel placed on the opposite side of the permanent magnets to the double legged core or cores. Flux then goes in a circuit from the North face of one permanent magnet across the air gap to one leg of the double legged preferably rectangular U shaped Core. Then it goes around the core and across the air gap from the other leg of the core to the adjacent permanent magnet of opposite polarity upon the rotor disk which is aligned with this core leg. Then it goes through that magnet and is guided by the ring shaped laminations behind the permanent magnets and on the other side to the double legged core, back to the first magnet from whence it came.

This essentially creates a UI transformer flux circuit interrupted by two permanent magnets placed between the two ends of the U core and the I core.

This is a superior magnetic circuit to the first embodiment described above, which omitted the I part of the UI core and therefore did not close the magnetic circuit. The result of closing the circuit is a more powerful and more efficient motor/generator with much less magnetic flux leakage. It is the full realisation of the inventive step of turning a transformer flux circuit into a motor/generator flux circuit.

The result when properly engineered in a preferred embodiment using sub 0.5 mm thickness grain oriented silicon steel for the U shaped stator core laminations and 0.5 mm thickness non oriented ring shaped laminations for the rotary equivalent of the I core behind the magnets on the rotor disk and using optimally wound coils on each leg of the double legged core made from rectangular cross section copper wire and using large cylindrical N52 grade Neodymium permanent magnets with a diameter larger than the diagonal of the U shaped core leg face and a length greater than their diameter and using a commutator for each coil on each leg of each U core made out of the latest generation of N channel MOSFETs in an H bridge configuration with each of the 4 switches in said configuration comprising multiple MOSFETs connected in parallel, is a total efficiency of both motor and commutator and speed controller of better than 98% at full power with a power density of better than 10 kW per kg. In a preferred embodiment the overall power losses in both the commutator and the speed controller and the motor can be less than 2% of total power supplied to the machine with a power density of 10 kW per kg.

Conventional magnetic machines whether AC or DC, which are based upon motor designs historic of more than 100 years achieve 90% at best for the motor and 2% at beast for the commutator and speed controller.

Description of an Embodiment Referred to as the Saturn n,m Motor/generator

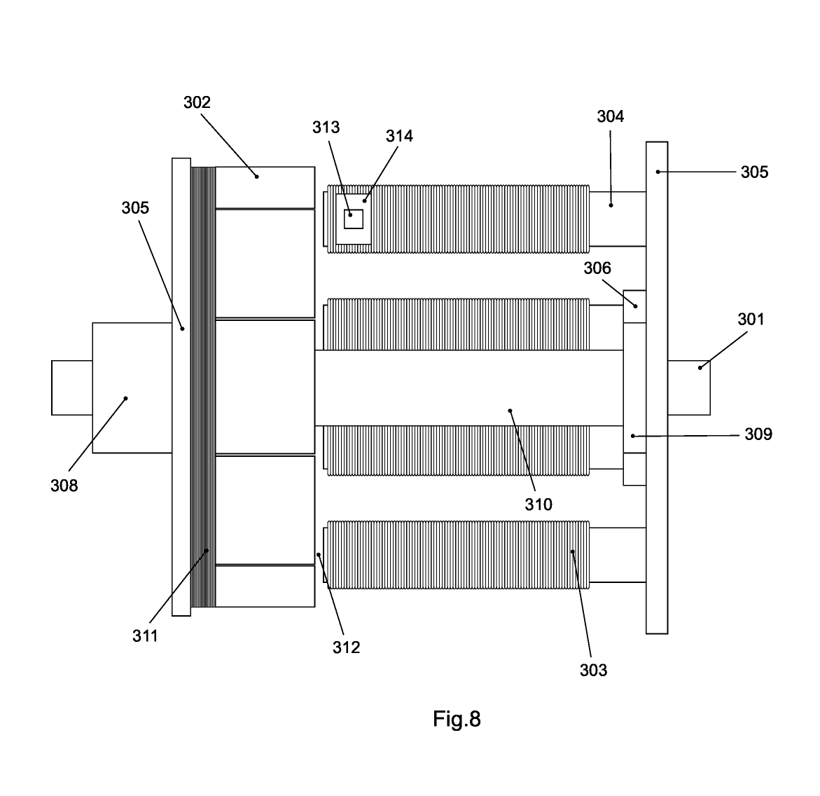

Referring to FIG. 8, in the first aspect of the invention there is provided a rotor shaft 301 and a bearing 309 and a bearing housing 306 to enable the rotor shaft to rotate efficiently.

In the preferred embodiment the bearing 309 is an angular contact bearing which can take the axial load created by the attraction of the permanent magnets 302 to the cores 304. In the preferred embodiment there is also provided a second bearing for the rotor shaft 301 and a second bearing housing for that bearing as is the case with most rotating machinery.

Here is the description of the components of the invention as shown in FIGS. 8, 9, 10
301 is the Rotor Shaft
302 is the Permanent Magnets affixed to the Rotor Disk 301
303 is the Stator Coils
304 is the Double Legged Stator Cores which are preferably U shaped
305 is the Rotor Disk
306 is the Bearing Housing
307 is the Motor End Plate to which the Stator Cores 304 are attached
308 is the Means for attaching the Rotor Disk 305 to the Rotor Shaft 301.
309 is the Bearing which is preferably an angular contact bearing
310 is the Means For Maintaining the air gap 12. Preferably a Rotor Shaft Collar
311 is the Magnetic Flux Returning Circuit. Preferably laminations
312 is the Air Gap between the Magnets 302 on the Rotor Disk 305 and the Stator Cores 304 on the Motor End Plate 7.
313 is the Rotor Disk Position Sensor
314 is the Sensor Position Adjustor.

Another aspect of this embodiment is the provision of a rotor disk 305 to which is affixed a circuit completing ring of high permeability magnetic material 311. The ring is concentric with the rotor disk. To this ring 311 are affixed an even number of permanent magnets 302 in a ring shaped pattern with the centres of the magnets forming a circle, the centre of which is the centre of the rotor disk 305 and the centre of the rotor shaft 301. The rotor disk is affixed to the rotor shaft with a fixing means 308. The permanent magnets are equidistant one from another and adjacent magnets have opposite polarity. The magnets 302 are magnetized in the direction of the axis of rotation of the rotor 1. The circuit completing ring 311 is preferably made of high permeability magnetic material and preferably designed to take all of the flux supplied by the permanent magnets 302 without too much magnetic saturation.

Another aspect of this embodiment is the provision of a stator comprising a motor end plate 307 to which are a affixed one or more double legged cores (304) made of high permeability magnetic material preferably electrical steel, preferably grain oriented silicon steel laminations. The double legged cores 304 are preferably U shaped and preferably rectangularized U shaped, which is indeed the shape of the U part of a standard commercial UI transformer core. The legs of these cores are preferably longer than in a standard UI transformer core.

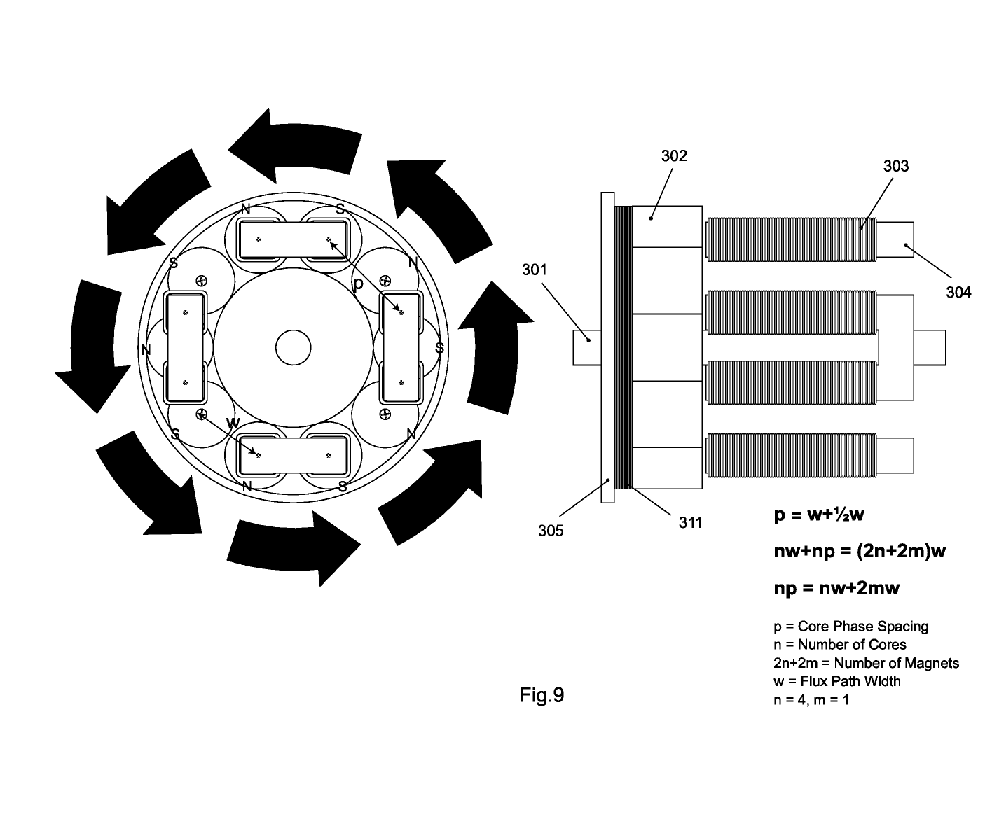

The double legged cores 304 are affixed to the motor end plate 7 in such a way that the two legs of the core 304 protrude towards the rotor disk 305. In the preferred embodiment of the invention, the centres of the legs of any one core 304 are the same distance apart as the centres of any two adjacent permanent magnets on the rotor disk. This distance is the flux path width of the magnetic circuit made by the U shaped core 304 and the permanent magnets 302 and the circuit completing ring 311. This flux path width is referred to as (w) in FIGS. 9-13.

Another aspect of this embodiment is the provision of an axial air gap 312 between the faces of the ends of the legs of each core 304 and the faces of the permanent magnets 302 on the rotor Disk 305—when said magnets are aligned with the U core legs. In the preferred embodiment of the invention each air gap 312 between each face of each leg of a stator core 304 and any aligned permanent magnet 302 is the same size. Said size is preferably between 0.5 mm and 10 mm.

In another aspect of this embodiment of a wound coil of electrically conductive wire 303 is provided upon each leg of the stator core 304.

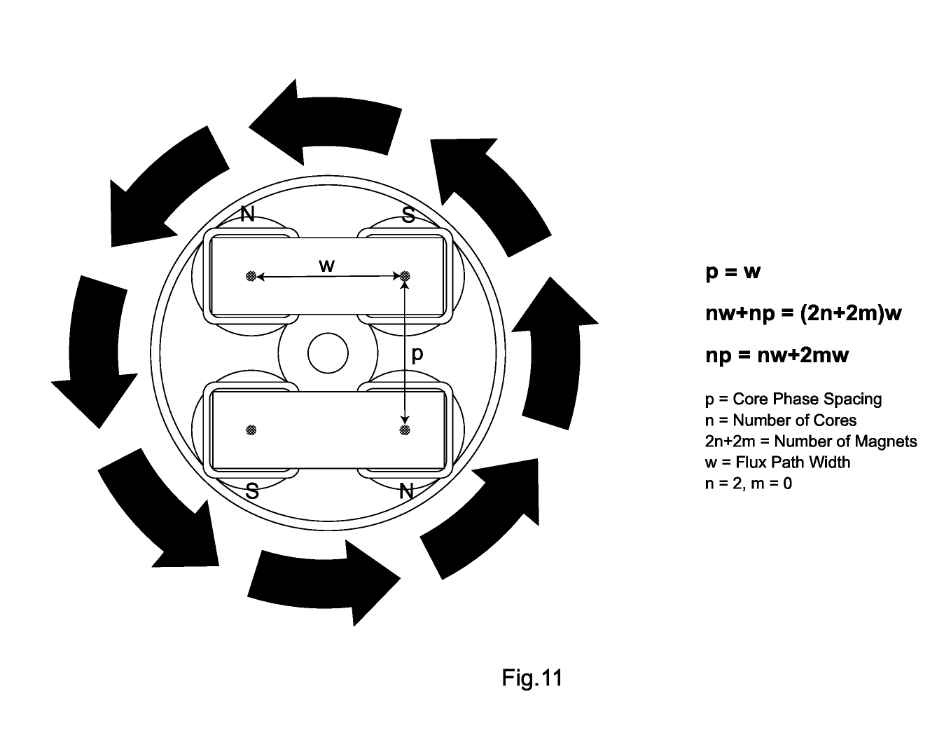

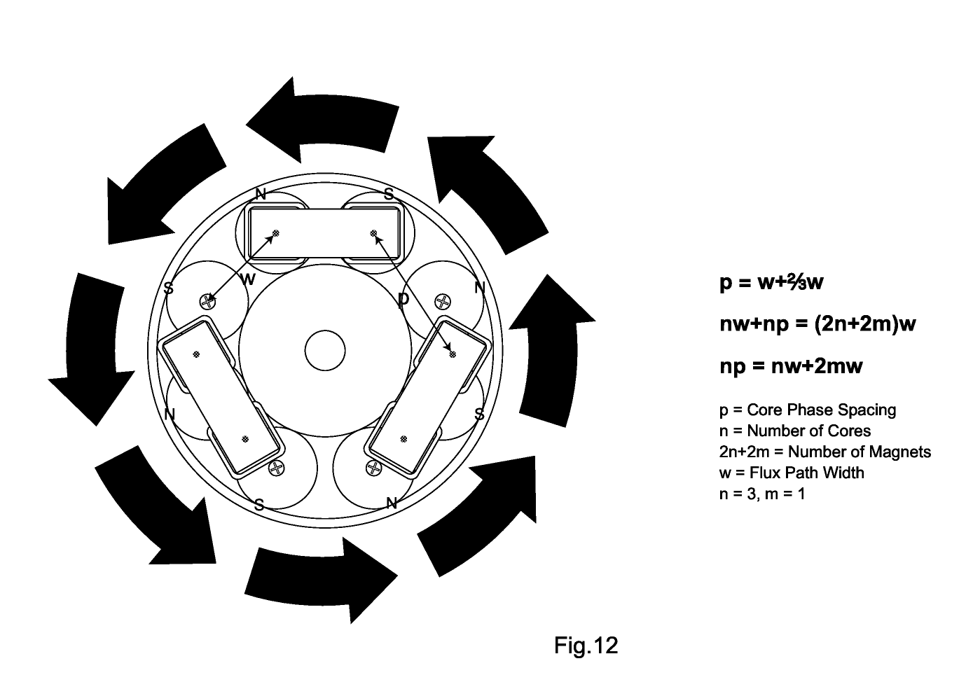

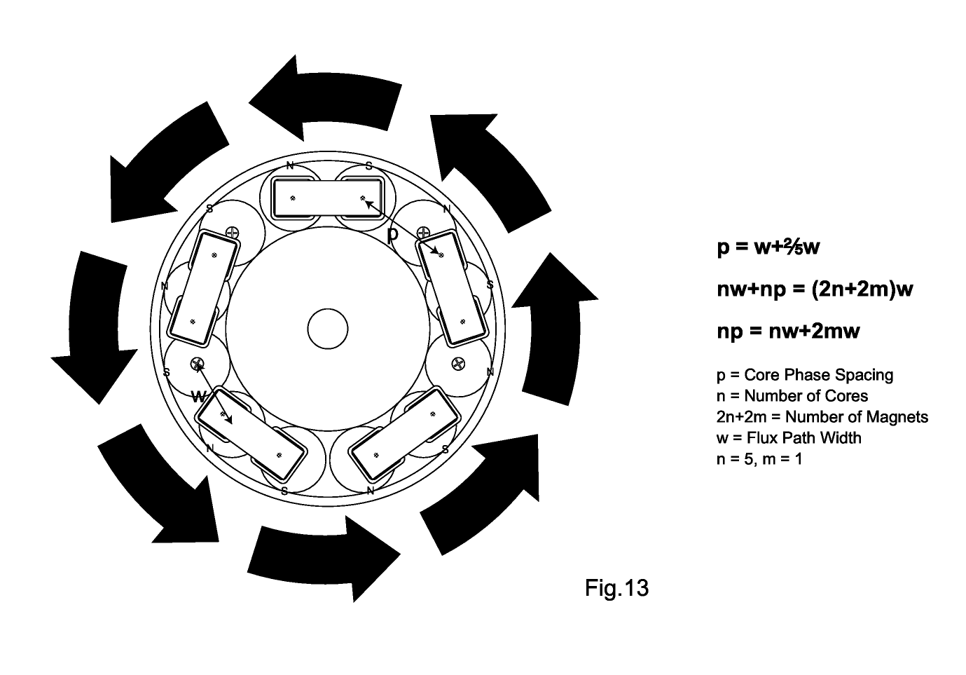

Another aspect of this embodiment is the provision of an adjacent core phase spacing p shown on FIG. 9, FIG. 11, FIG. 12, FIG. 13 between the centres of legs of two adjacent stator cores. The ratio of this core spacing (p) to the flux path width (w) determines the number of phases that the machine has.

Another aspect of this embodiment is the provision of a means for preventing the rotor disk from sliding down the rotor shaft and attaching itself magnetically to the stator cores. It really wants to do this! Said means is preferably a shaft collar 310 of FIG. 8, which extends from the rotor Disk 305 to the bearing 309 and therefore physically prevents this occurring. The shaft collar guarantees the maintenance of the air gap 312.

In the preferred realisation of this embodiment there is provided a naming system as follows.

The machine is called a Saturn n, 2n+2m (n,m are integers. n>0 and m>0 or m=0)
n=number of double legged cores on stator
2n+2m=number of magnets on rotor

The flux path width
w=the distance between the centres of the magnets
=The distance between the centres of the 2 U core legs

The core phase spacing
p=the distance between the leg centres of two adjacent U cores.

p defines the number of phases in the motor.
A Single phase machine has p=rw (r=1,2,3 etc. any integer >0).
2 phase has p=(r+1/2)w
3 phase has p=(r+1/3 or 2/3)w
4 phase has p=(r+1/4 or 3/4)w
5 phase has p=(r+1/5 or 2/5 or 3/5 or 4/5)w
6 phase has p=(r+1/6 or 5/6)w
7 phase has p=(r+1/7 or 2/7 or 3/7 or 4/7 or 5/7 or 6/7)w
8 phase has p=(r+1/8 or 3/8 or 5/8 or 7/8)w
9 phase has p=(r+1/9 or 2/9 or 4/9 or 5/9 or 7/9 or 8/9)w
10 phase has p=(r+1/10 or 3/10 or 7/10 or 9/10)w
11 phase has p=(r+1/11 or 2/11 or 3/11 or 4/11 or 5/11 or 6/11 or 7/11 or 8/11 or 9/11 or 10/11)w
12 phase has p=(r+1/12 or 5/12 or 7/12 or 11/12)w Etc. Etc.

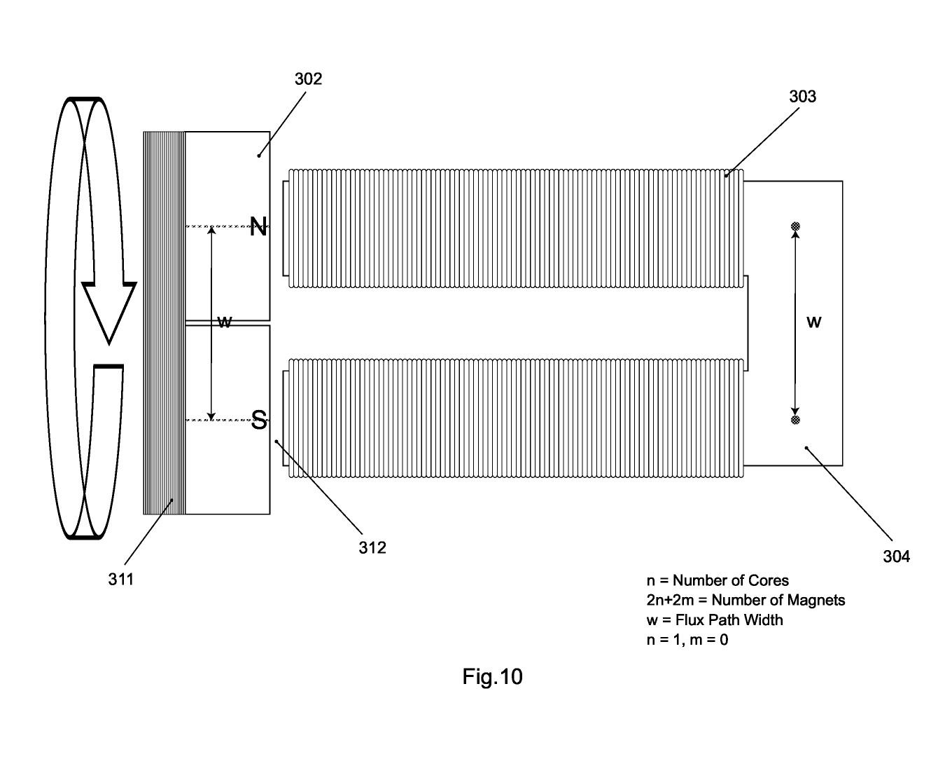

The general formula for an n phase machine contains every fraction with denominator n which is greater than 0 and less than 1 and which can be reduced.
The motor in FIG. 9 is a Saturn 4,10 2-phase machine.
The motor in FIG. 10 is a Saturn 1,2 single phase machine
The motor in FIG. 11 is a Saturn 2,4 single phase machine
The motor in FIG. 12 is a Saturn 3,8 3-phase machine.
The motor in FIG. 13 is a Saturn 5,10 5-phase machine.
The 7 aspects of the invention described above are sufficient for an electric generator.

A Motor Embodiment

In the 1^{st} aspect of the motor embodiment of the invention there is provided a rotor position sensing means 313 for each phase of the machine. Said means is preferably a hall effect magnetic sensor or an optical sensor arrangement in the case of a brushless motor. And it is simply an arrangement of conducting material affixed to the rotor shaft in the case of a brushed motor. This sensing means determines the rotational position of the rotor disk 305 and therefore also of the permanent magnets upon it.

In the preferred embodiment of the 1^{st} aspect of the motor embodiment of the invention there is provided a means 314 of adjusting the position of the rotor position sensing means 313. Said sensor position adjusting means can be used to advance or retard the timing of the commutation of the coils 303. So each phase of the machine has both a rotor position sensing means 313 and a means 314 for adjusting the position of the rotor position sensing means.

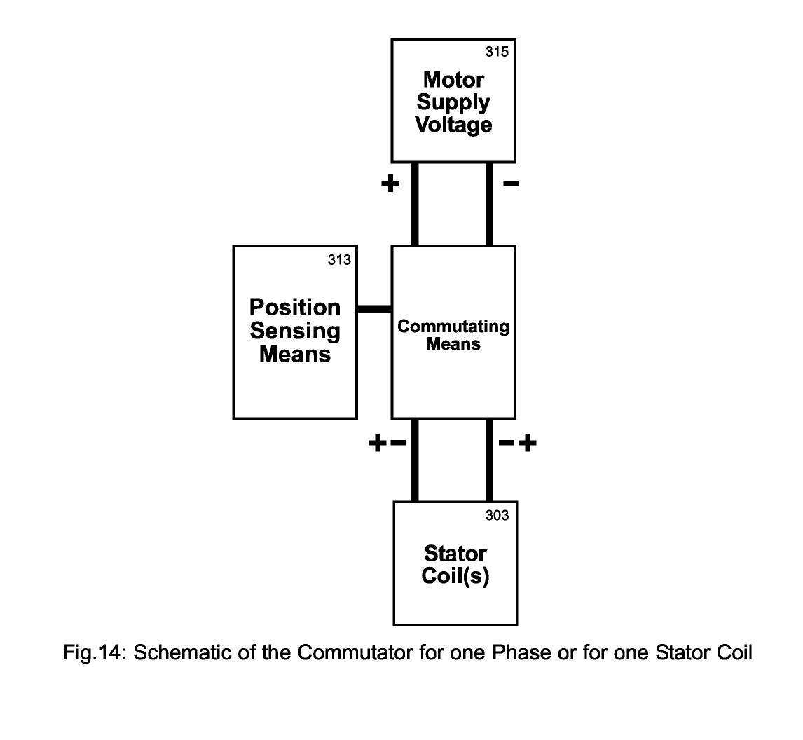

In the 2^{nd} aspect of the motor embodiment of the invention there is provided a commutating means which responds to the rotor position sensing means 313 as shown in FIG. 14. Said commutating means connects the two ends of the wires of the coils 303 to the motor supply voltage and then disconnects them and reconnects them the other way around when the rotor disk reaches a position determined by the position sensing means 313. The commutating means does this repeatedly upon receiving information from the rotor position sensing means in such a way as to cause the rotor disk to rotate.

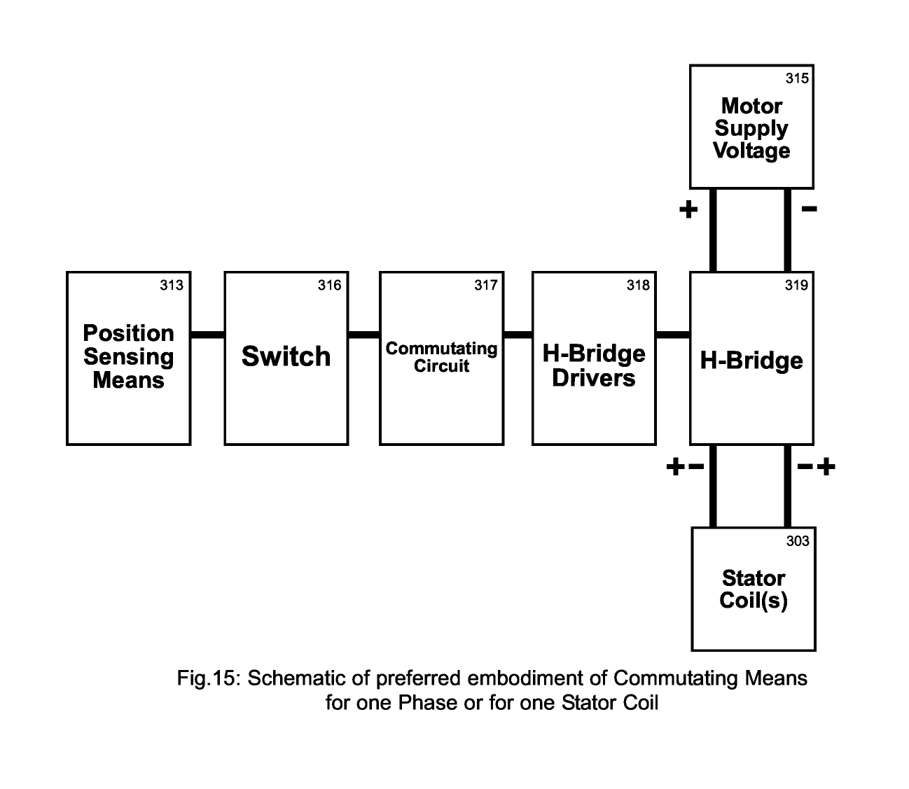

In the preferred embodiment of the 2^{nd} aspect of the motor embodiment of the invention, FIG. 15, the rotor position sensing means 313 is a Hall effect sensor which operates a switch at certain flux levels. The invention provides a sensor 313 and a switch 316 for each phase of the motor and the commutation means for each phase or for each coil is instructed by said switch or switches. In said preferred embodiment the commutation means consists of an H bridge circuit 319, with each of the 4 switches in the H bridge circuit being one or more MOSFETs as shown in FIG. 15.

In the most preferred embodiment each MOSFET switch comprises several MOSFETs connected in parallel.

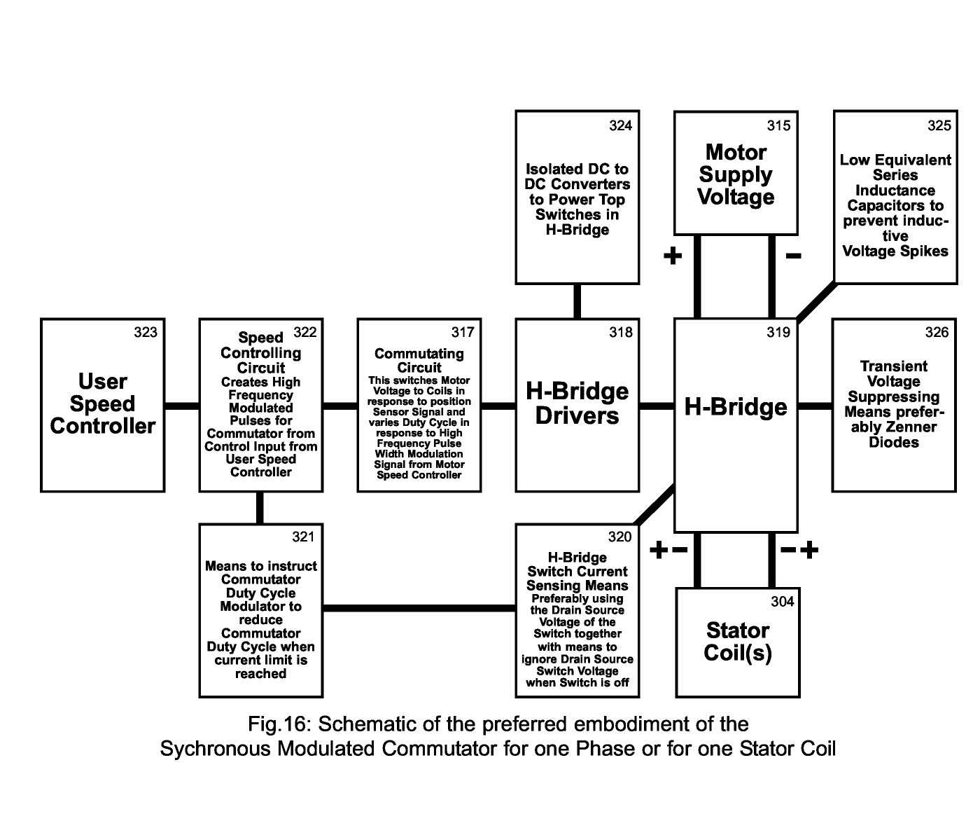

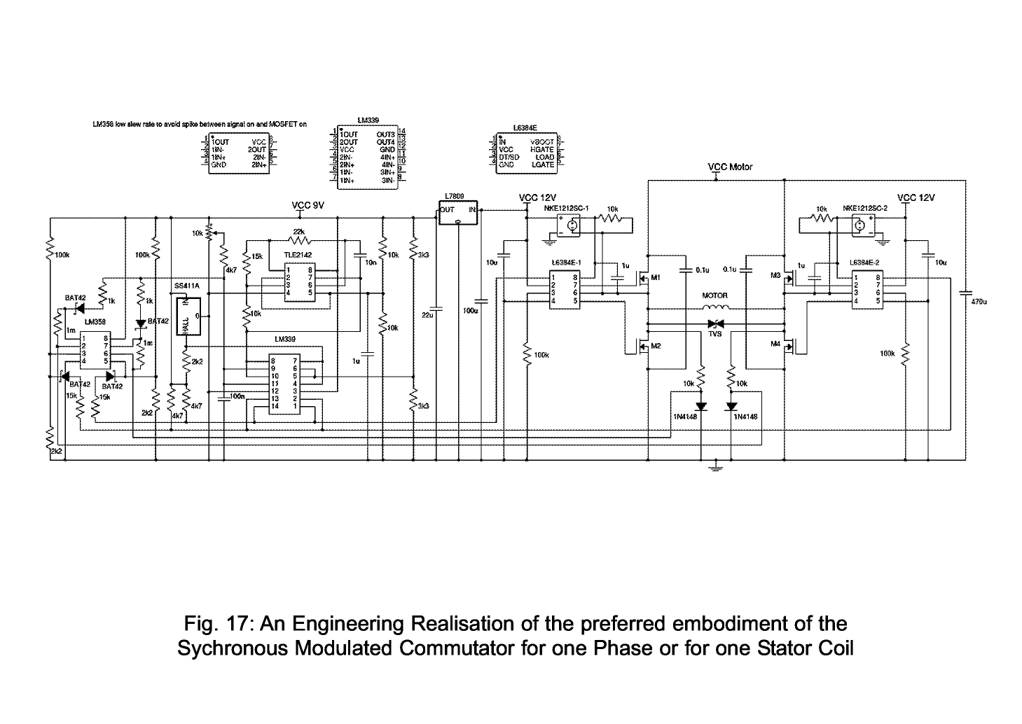

In one embodiment of the commutator aspect of the motor embodiment of the invention all the MOSFETs are n-channel devices. The H bridge 319, is driven by a full bridge driver chip or circuit or by two half bridge driver chips or circuits 318, which are provided with a power supply from one or two isolated DC to DC converters 324, which create voltages sufficient to drive the gates of the two upper MOSFETs in the bridge (the two MOSFETS with their drains connected to the positive terminal of the motor power supply) as shown in FIG. 16.

In one embodiment of the commutator aspect of the motor embodiment of the invention there are provided low equivalent series inductance capacitors 325, positioned as near as possible to each MOSFET to reduce inductive spikes as shown in FIG. 16.

In one embodiment of the commutator aspect of the motor embodiment of the invention there is a provided a current limiting means to protect the MOSFETs from excessive current which may occur in certain states of motor operation—such as if the motor is forcibly stalled. In the preferred embodiment of the motor embodiment of the invention there is provided an H bridge switch current sensing means 320, and a means to instruct the commutating circuit 317 to reduce its duty cycle when a certain current limit is reached.

In one embodiment of the commutator aspect of the motor embodiment of the invention there is a provided voltage limiting means 326, to protect the MOSFETs from excessive Drain Source voltage. Said means is preferably one or more Zenner diode type devices—as shown in FIG. 16.

In the 3^{rd} aspect of the motor embodiment of the invention there is provided a commutation modulation means as shown in FIG. 16 to control the speed of the rotor disk.

Said commutation modulation means may be synchronous or asynchronous. In the preferred embodiment of this aspect of the motor embodiment of the invention, the commutation means is synchronous and it provides for an H bridge state where both the lower MOSFETs are on and both the upper MOSFETS are off. In this state the motor freewheels with no power being taken from the motor power supply by the coils. The lower MOSFETs both act as near perfect freewheeling diodes. This aspect was invented upon the realisation that an H bridge is in fact two synchronous buck converters facing each other. So the H bridge can itself be used as a synchronous buck converter. It is known to use pulse width modulated commutation for the speed control of conventional DC motors. But prior art uses the integral body diodes in the MOSFETs as the freewheeling diodes. This aspect of the motor embodiment of the invention actually turns both the lower MOSFETS in the H bridge on and thereby uses the MOSFETs themselves as the freewheeling diodes just as a synchronous buck converter does. The advantage of this is that the drain source impedance of a turned on MOSFET is a lot less than that of the integral body diode when the MOSFET is turned off.

So the preferred embodiment of this aspect of the motor embodiment of the invention is a synchronous commutation modulation means using turned on MOSFETs as freewheeling diodes rather than an asynchronous commutation modulation means using integral body diodes of turned off MOSFETs. The synchronous commutation modulation means disconnects the coils 4 from the motor power supply and turns on both lower MOSFET switches in the H bridge to act as near perfect freewheeling diodes for a chosen percentage of the commutator duty cycle. Choosing that percentage determines the ratio of applied power time to freewheeling time in each commutation duty cycle and that determines the speed of the rotor disk.

The User Speed Controller 323, instructs the Speed Controlling Circuit 322, which varies the duty cycle of the commutating circuit 317, which varies the speed of the rotor Disk 305. The current limit circuitry 321, also instructs the Speed Controlling Circuit 322 which further varies the duty cycle of the commutating circuit 317.

In one embodiment of the invention there is provided a means to separate the rotor from the stator—which cannot in general be done manually. In the preferred version of this embodiment said means is a threaded bar affixed to the motor end plate 307, and a screw which goes through the threaded bar in such a way as to be able to push the rotor shaft 301 away from the stator.

Improved Rotor

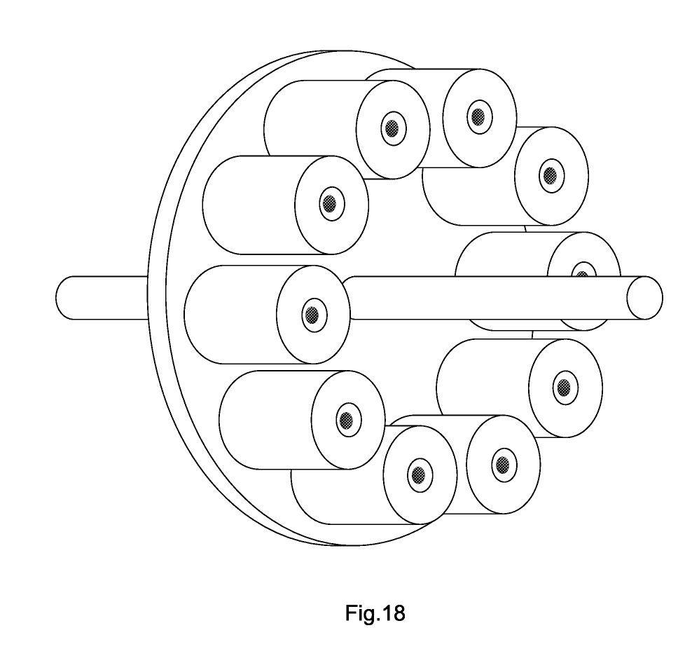

FIG. 18 to FIG. 22 show the evolution of improvements to the rotor design of the Saturn n.m motor.

FIG. 18: Cylindrical magnets magnetized axially with alternating polarity fastened to the rotor.

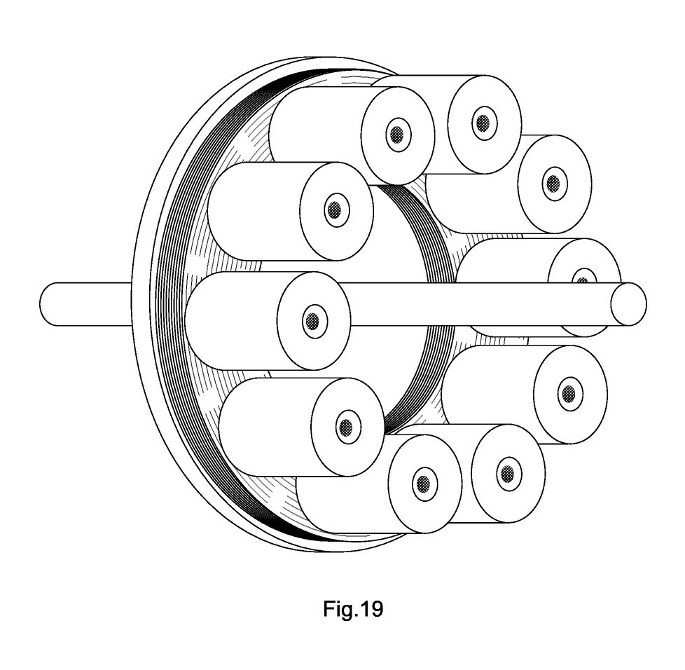

FIG. 19: Cylindrical magnets magnetized axially with alternating polarity fastened to flux returning slotted rings of high permeability material which are fastened to the rotor.

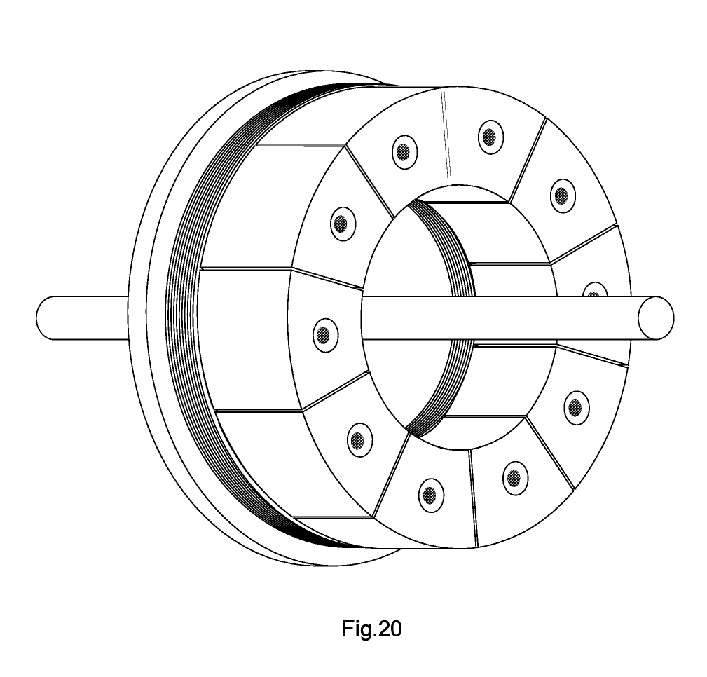

FIG. 20: Arc shaped magnets magnetized axially with alternating polarity fastened to flux returning slotted rings of high permeability material which are fastened to the rotor.

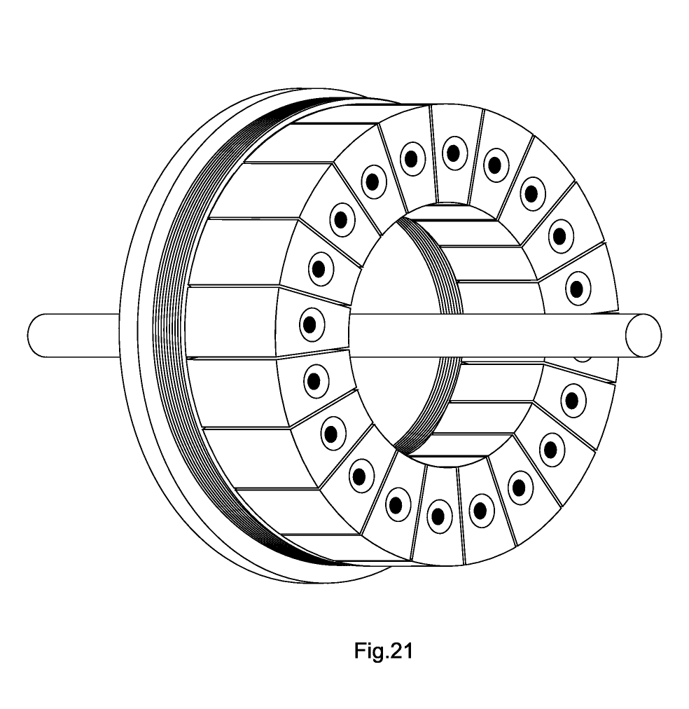

FIG. 21: Half thickness (to reduced eddy current losses) arc shaped magnets magnetized axially with alternating polarity fastened to flux returning slotted rings of high permeability material which are fastened to the rotor.

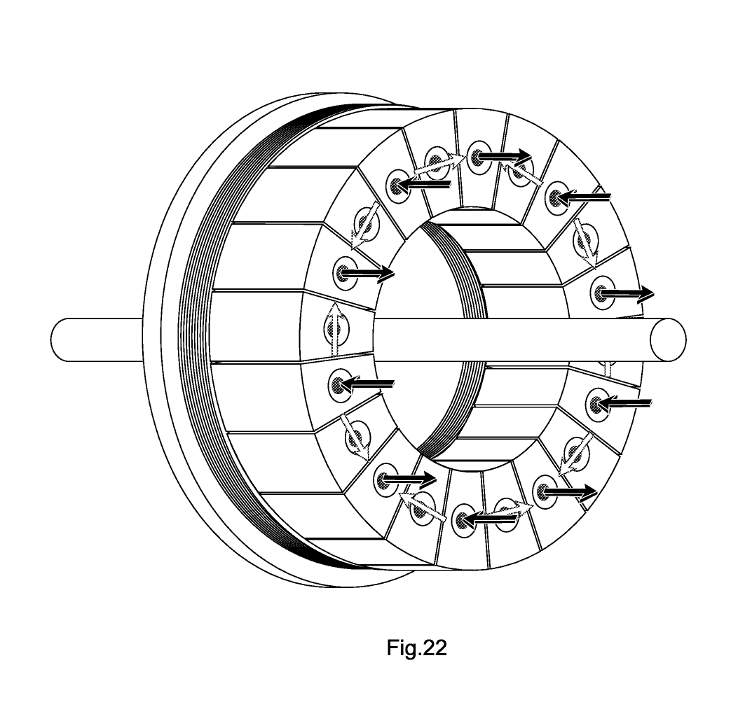

FIG. 22: Half thickness (to reduced eddy current losses) arc shaped magnets magnetized as an axial Halbach array preferably fastened to flux returning slotted rings of high permeability material which are fastened to the rotor.

In the Halbach array configuration of FIG. 22, counting from an axially magnetized magnet as number 1, the odd numbered magnets are magnetized axially with alternating polarity and the even numbered magnets are magnetized circumferentially with alternating polarity. The Halbach array concentrates the magnetic flux strongly on one side of the array and weakly on the other. The result is that on the chosen side of the array a higher flux density is achieved than one can with a simple alternating pattern of axially magnetized magnets—which distributes the flux density equally on both sides of the array.

Description of Improved Rotor for Axial Flux Motor.

According to the arc magnet embodiment of the improved rotor, there are provided arc shaped magnets which fit together to form a ring around the rotor in a manner depicted in FIG. 20.

According to the half thickness arc magnet embodiment of the improved rotor, there are provided half thickness arc shaped magnets which fit together to form a ring around the rotor in a manner depicted in FIG. 20. The design is intended to reduce eddy current losses in the magnets by halving the thickness of each one. The magnets are magnetized axially in pairs according to a NN, SS, NN, SS pattern. The result is the same as FIG. 20 except that each magnet is split in two and an insulator (such as an air gap) exists between the two half thick magnets so that an electrical current cannot pass from the one to the other.

According to the preferred embodiment of the present improvement of the present invention there is therefore provided a Halbach array comprising an integral multiple of 4 magnets (4, 8, 12, 16, 20, 24 etc.) magnetized in the known Halbach pattern so as to increase the flux density on the side of the array facing the stator cores.

Lower Eddy Current Loss Arc sliced shaped Magnet Rotor Embodiment

Motor cogging, wherein the rotor is pulled into preferred rotational positions, is caused by having non arc shaped discreet magnets on the rotor as shown in FIG. 18 and FIG. 19. These pull the rotor into a position where the centre of the magnet is about the centre of the stator core leg. Cogging is avoided if a continuous arc is made out of discreet magnets as shown in FIG. 20, FIG. 21 and FIG. 22.

The Halbach arrangement in FIG. 22 produces the most rotationally symmetric and rotationally uniform magnetic field and therefore has very little cogging. But it has higher losses due to the higher field strength.

So we need to reduce the loss in the magnets upon the rotor. Am arc shaped permanent magnet is effectively a solid cored electromagnet with an invisible zero weight induction coil which uses no power. With this analogy it is easy to see that just as we laminate transformer cores in order to reduce eddy current losses. So we should segment or slice or laminate permanent magnets to reduce induced eddy current losses in them. Neodymium Magnets have over 3× the resistivity of silicon steel, and experience a smaller change of flux than the stator cores in the invention. So we do not need to slice them up as aggressively as we do with silicon steel laminations in the stator cores. But we still need to slice them up in order to reduce their losses and get an efficient motor design.

So the preferred embodiment of the invention has segmented or sliced or laminated rotor magnets which segments slices or laminations are electrically insulated one from another in order to reduce eddy current path length. The general rule for this is that halving the thickness of the segment slice or lamination will quarter the eddy current losses. Eddy current losses very with the square of the thickness of the lamination.

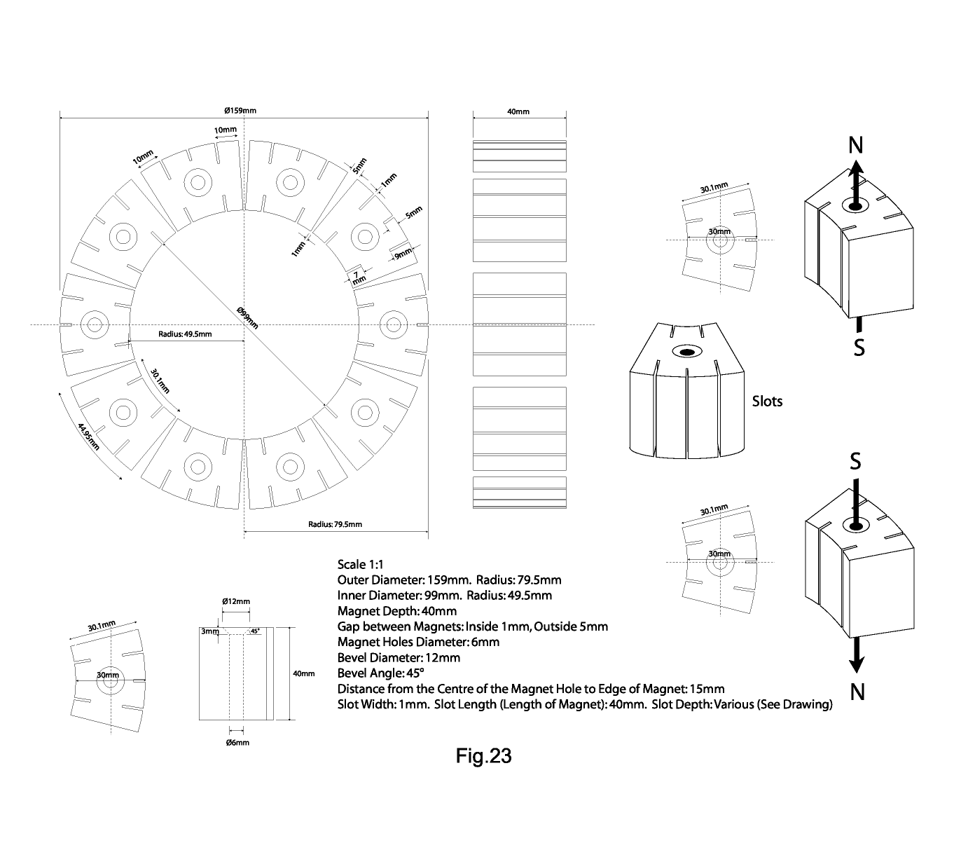

FIG. 23 shows the pineapple embodiment of slotted rotor magnets.

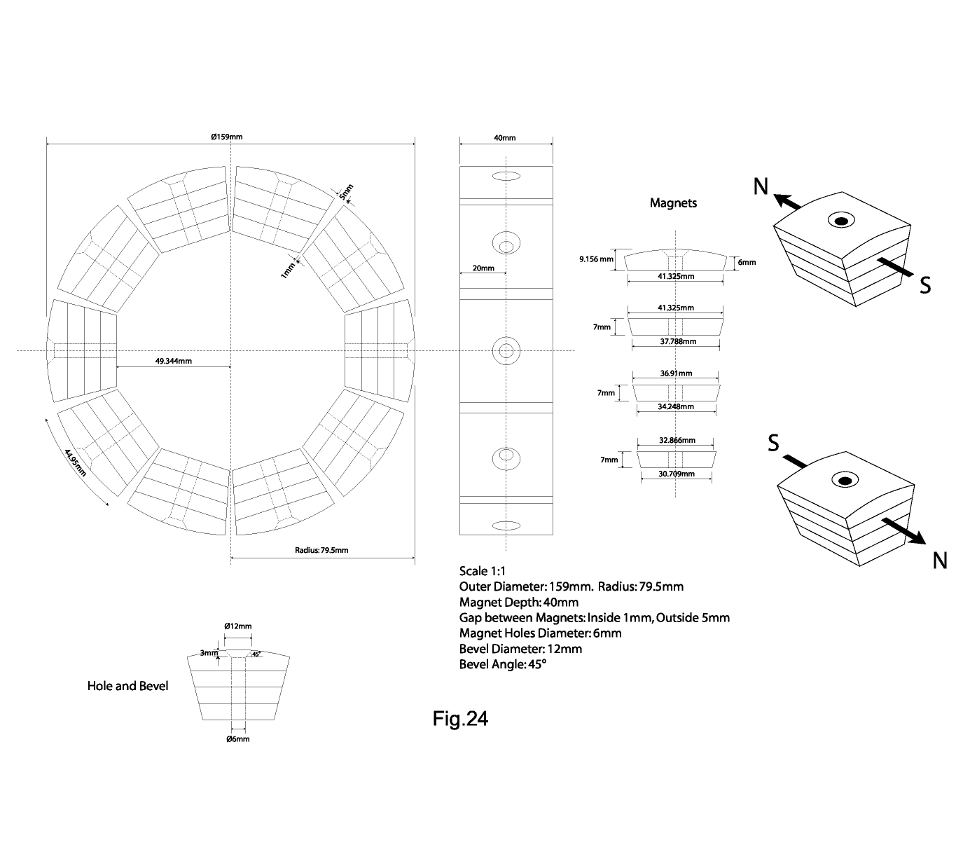

FIG. 24 shows the spider's web embodiment of sliced rotor magnets.

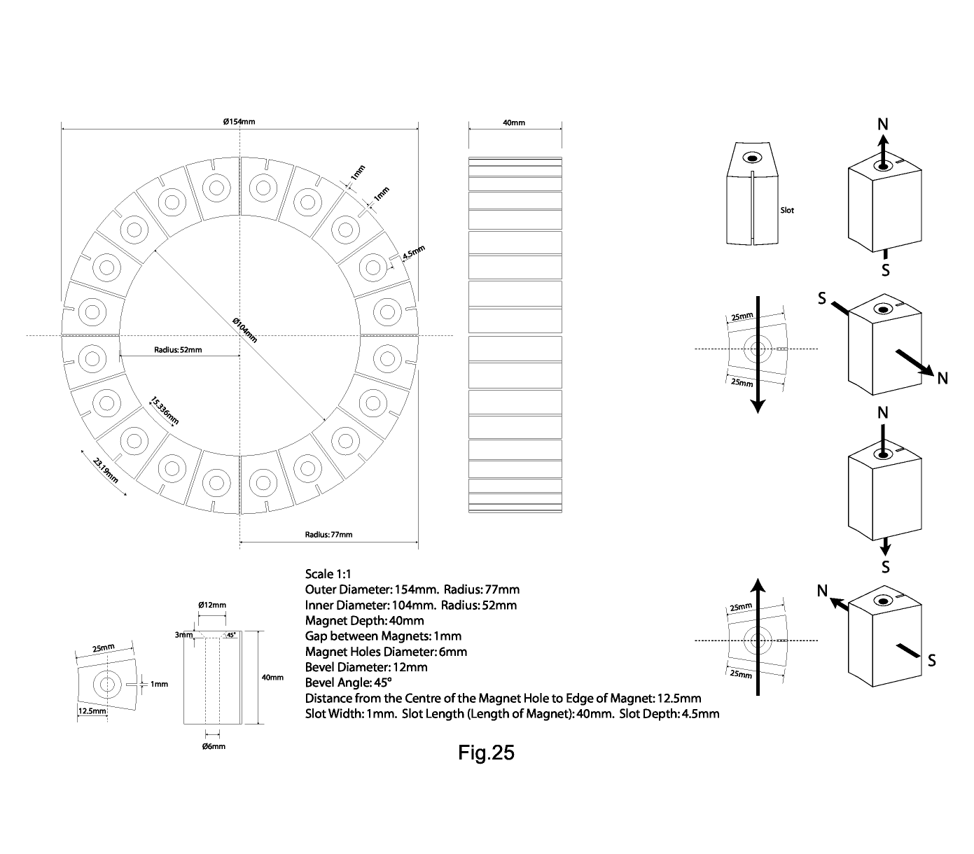

FIG. 25 shows the pineapple embodiment of half thickness slotted rotor magnets.

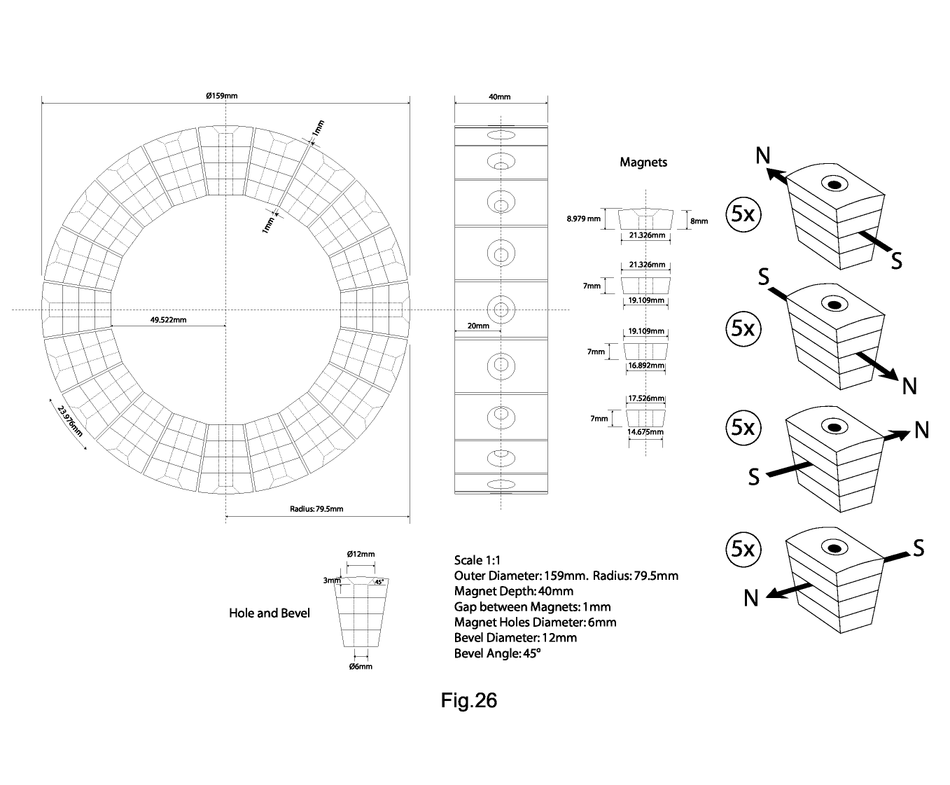

FIG. 26 shows the spider's web embodiment of half thickness halbach slotted rotor magnets.

Both designs reduce the available path in which eddy currents can flow.

So in general terms, in the preferred embodiment of the invention, the permanent magnets upon the rotor incorporate eddy current reducing means in their design.

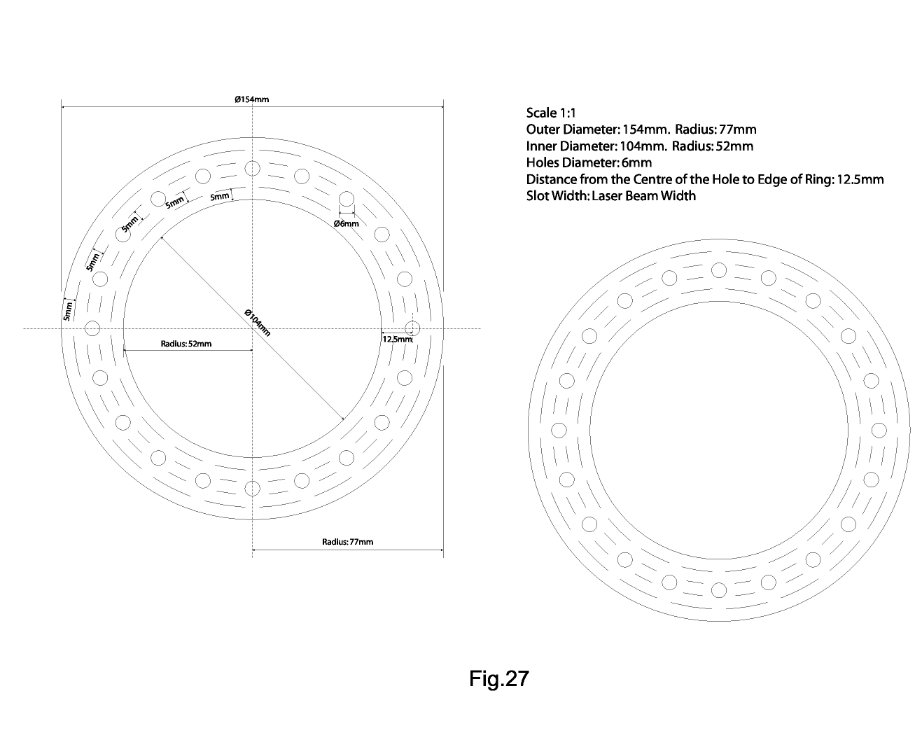

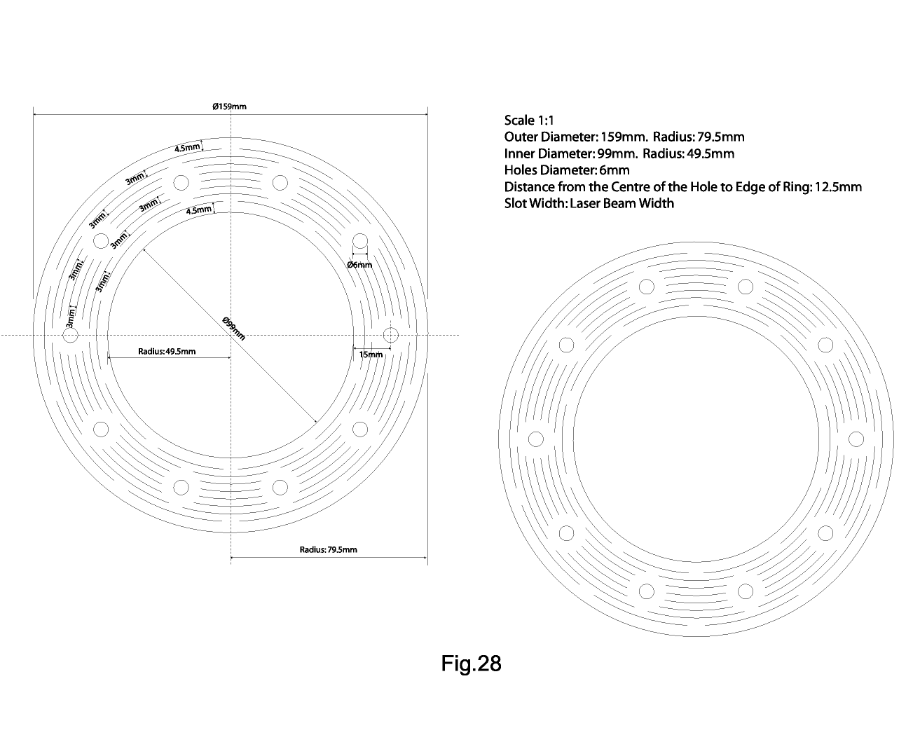

Likewise the electrical steel rings which are placed between the rotor magnets and the rotor disk are preferably slotted to reduce eddy current paths in them. FIG. 27 and FIG. 28 are examples of such a rings.

Preferred High Efficiency Embodiment

1. Discreet arc shaped magnets in a continuous ring on the rotor, slotted or segmented to reduce eddy currents

2. Single sided stator with slotted electrical steel rings between the rotor magnets and the rotor disk, to reduce eddy currents.

3. Alternating polarity axial magnetization or halbach array axial magnetization of rotor magnets.

4. Grain oriented silicon steel stator core U shaded laminations with elongated legs.

5. Rectangular copper wire stator windings.

6. Stator cores offset with respect to rotor magnets to provide multiphase operation.

7. Neodymium based permanent magnets

8. Synchronous modulated commutation to control the speed of the motor.

1. An axial flux rotating machine comprising:
a rotatable component including a rotor having an axis of rotation and an even number of permanent magnets disposed around said axis in a circle at a radial distance from said axis and supported for rotation about said axis; and
a stator component comprising at least one open ended transformer core member with one or more electrically conductive wire coils around the core member, said transformer core member and said rotatable component being aligned so that the permanent magnets induce an alternating magnetic field in the open ended transformer cores when the rotatable component rotates.

2. The axial flux rotating machine of claim 1, wherein the open ended transformer core has two ends which face in the same direction and which face adjacent permanent magnets of opposite polarity.

3. The axial flux rotating machine of claim 1, wherein the open ended transformer cores have two ends which face in the same direction and which are aligned to receive the magnetic flux from the permanent magnets.

4. The axial flux rotating machine of claim 3, wherein the centres of the two ends of the transformer cores are aligned with the centres of the faces of adjacent permanent magnets

5. The axial flux rotating machine of claim 1, wherein the rotor comprises a rotor disc, each of said permanent magnets being mounted to said rotor disc.

6. The axial flux rotating machine of claim 1, further comprising means for maintaining a narrow gap between the permanent magnets and the ends of the one or more open transformer cores.

7. The axial flux rotating machine of claim 6 wherein the means for maintaining a narrow gap comprises one of: a collar disposed between said rotor disc and a bearing supporting the rotor, wherein the collar is formed of a low elasticity material for resisting compression; and shaft clamps mounted on a shaft of said rotor.

8. The axial flux rotating machine of claim 1, wherein the magnets are arranged in an alternating sequence of opposite polarity around said axis.

9. The axial flux rotating machine of claim 1, wherein at least one of said transformer core members is one of: U-shaped, C-Shaped, square U-shaped, and horseshoe shaped, and positioned so as to provide a magnetic path between adjacent permanent magnets upon the rotor.

10. The axial flux rotating machine of claim 1, wherein the transformer core is formed of laminated sheets.

11. The axial flux rotating machine of claim 1, wherein the permanent magnets each have an axial length that is greater than a width of the magnet.

12. The axial flux rotating machine of claim 1, wherein the permanent magnets are cylindrical.

13. The axial flux rotating machine of claim 1, wherein the permanent magnets have an arc shape.

14. The axial flux rotating machine of claim 1, wherein the discreet permanent magnets form a substantially continuous ring in order that the rotor seeks no substantially preferred angular position.

15. The axial flux rotating machine of claim 1 wherein the permanent magnets have a flux carrier on the opposite side to the stator cores, which feeds the magnetic flux from one permanent magnet to another.

16. The axial flux rotating machine of claim 15 wherein the flux carrier comprises ferromagnetic rings on the opposite side of the permanent magnets to the stator cores.

17. The axial flux rotating machine of claim 15, wherein said flux carrier is one of: laminated; slotted; and laminated and slotted, to reduce eddy currents.

18. The axial flux rotating machine of claim 15, wherein said flux carrier comprises one of slotted and unslotted ferromagnetic ring laminations.

19. The axial flux rotating machine of claim 15 wherein said ferromagnetic rings comprise ferromagnetic silicon steel.

20. The axial flux rotating machine of claim 1, wherein the permanent magnets are sliced or segmented with said slices or segments insulated one from the other so as to reduce eddy current paths within the magnets

21. The axial flux rotating machine of claim 1, wherein the permanent magnets are slotted so as to reduce eddy current paths within the magnets

22. The axial flux rotating machine of claim 1 wherein the permanent magnets are arranged in a Halbach array magnetization pattern which increases their magnetic flux density on the side of the stator cores and reduces it on their other side.

23. The axial flux rotating machine of claim 22, wherein the open ended transformer cores have two ends which face in the same direction and which face two magnets in the Halbach array with opposing polarity which are separated by one other magnet in the Halbach array.

24. The axial flux rotating machine of claim 1, configured for operation as a motor, and further comprising a commutator for providing alternating current to said conductive wire coils synchronized to the position of the rotor, wherein the commutator comprises one of: a brush type commutator, a brushless commutator including one or more position sensors for monitoring a position of said rotor, and an electronic commutator comprising semiconductor switches.

25. The axial flux rotating machine of claim 24 wherein the commutator is pulse width modulated so as to control the power supply to the motor.

26. The axial flux rotating machine of claim 25 wherein the commutator is pulse width modulated using MOSFETs as synchronous freewheeling diodes, so as to control the power supply to the motor efficiently.

27. The axial flux rotating machine of claim 1, configured for operation as one or any combination of an alternator, generator and motor.

28. The axial flux rotating machine of claim 1 having a plurality of pairs of said permanent magnets of opposing polarity and a plurality of open ended transformer cores.

29. The axial flux rotating machine of claim 1, wherein the number of permanent magnet pairs and the number of stator cores are selected and these are positioned in such a way as to create a single phase machine.

30. The axial flux rotating machine of claim 1, wherein the number of permanent magnet pairs and the number of stator cores are selected and these are positioned in such a way as to create a multi-phase machine.

31. The axial flux rotating machine of claim 1, wherein the number of permanent magnet pairs and the number of stator cores are selected and these are positioned in such a way as to reduce a tendency for the rotor to seek a preferred position.

32. The axial flux rotating machine of claim 31 wherein the number of said pairs of permanent magnets is one greater than the number of open ended transformer cores.

33. The axial flux rotating machine of claim 5, wherein the open ended transformer cores are all located on the same side of the permanent magnets on the rotor disc.

34. The axial flux rotating machine of claim 5, wherein the open ended transformer cores are located on both sides of the permanent magnets and the rotor disc.

35. An axial flux rotating machine comprising:
a rotatable component including a rotor having an axis of rotation and an even number of permanent magnets arranged in a circle at a radial distance from said axis and supported for rotation about said axis;
a stator component comprising at least one open ended transformer core member with one or more electrically conductive wire coils around the core member, said transformer core disposed on one side of the circle of permanent magnets and aligned so that the permanent magnets induce an alternating magnetic field in the open ended transformer cores when the rotatable component rotates; and
a flux carrier on the opposite side of the magnets to the stator transformer cores, which feeds the magnetic flux from one permanent magnet to another.

36. An axial flux rotating machine comprising:
a rotatable component including a rotor having an axis of rotation and a number of permanent magnets that is a multiple of four, wherein the magnets are arranged as a Halbach array in a circle at a radial distance from said axis and supported for rotation about said axis; and
a stator component comprising at least one open ended transformer core member with one or more electrically conductive wire coils around the core member, said transformer core member and said rotatable component being aligned so that the permanent magnets induce an alternating magnetic field in the open ended transformer cores when the rotatable component rotates.
